(19) United States
(12) Patent Application Publication
(10) Pub. No.: US 2012/0009537 A1
(43) Pub. Date: Jan. 12, 2012

(54) Orthodontic Appliance

(76) Inventor: Mikiko Nagai, Suzaka City (JP)

(21) Appl. No.: 12/831,448

(22) Filed: Jul. 7, 2010

(51) Int. Cl. A61C 7/00

(52) U.S. Cl. 433/2

(57) ABSTRACT

The present invention provides an orthodontic appliance and wearing the orthodontic appliance can change the occlusion so as to solve the problem of conventional orthodontic appliance that might take long treatment duration. Through providing the orthodontic appliance to children with deciduous tooth, the permanent first molar can protrude from current position and move toward the neutral zone with better balance. Also, the present invention is invisible so as to concern user's feeling.

### FIELD

The exemplary embodiments of the present invention relates to a field of orthodontic appliances. More specifically, the exemplary embodiments of the present invention relates to an orthodontic appliance that can easily apply to orthodontics treatment.

### BACKGROUND

There are many conventional orthodontic appliances available now, such as Bionator, Bimler, and MUH Shield.

These conventional orthodontic appliances are all based on the background art that normal muscle function guides correct occlusion, and abnormal muscle function leads to dentofacial deformity. Thus, the purpose of the orthodontic treatment is to restore normal muscle function, to adjust the balance of the muscle function, and further to reform the teeth by the balance of the muscle function. The advantages of the conventional orthodontic appliance are listed as following:

1. The aforementioned orthodontic appliance is removable and implanted only at night.

2. Younger Children can also use the aforementioned orthodontic appliance without feeling pain.

3. No need to perform the teeth extraction.

4. Dental caries are not easily happened.

5. The changing back situation is less happened.

6. The teeth and the jaw can be treated constantly and together.

7. The complete occlusion of the upper jaw and the lower jaw can be achieved.

8. Onychophagia or nail biting can be treated.

9. The removal of the orthodontic appliances will not cause worse situation even in the worse case scenario.

The muscle function can be restored by utilizing the orthodontic appliance. Because the longer patient wearing the orthodontic appliances, the better treatment result can be achieved. Therefore, it would be ideal that using the orthodontic appliances day and night. To avoid the difficulties of dining and the unfavorable appearance of the orthodontic appliances, the aforementioned orthodontic appliances are removable, and thus considering the patient's feeling of the unapparent orthodontic appliances and avoiding the situation that children with the orthodontic appliances are teased and thus loathing the treatment.

In addition, the main purpose of the orthodontic appliance is restoring the normal muscle function for guiding completed occlusion. However, the conventional orthodontic appliances all take longer time to achieve the key point of the treatment, and the users also suffer from the uncomfortable feeling in the mouth and thus generate different levels of complains.

### SUMMARY

An orthodontic appliance is disclosed due to the aforementioned situation. The orthodontic appliances in the present invention can significantly decrease uncomfortable feeling caused by the installation of the orthodontic appliance on the patient's teeth. Further, the orthodontic appliance in the present invention is fixed in stead of removable, and thus can achieve the best result because the result is proportioned to the treatment duration. Because applying the orthodontic appliance can change the occlusion, the convention orthodontic appliances take longer time to achieve the key point of the occlusion.

Besides, another object of the present invention is providing an orthodontic appliance to children with deciduous tooth, rendering the permanent first molars protruding from the current position, and further moving the permanent first molars toward the neutral zone with better balance.

Moreover, another object of the present invention is providing an orthodontic appliance to consider user's feeling about people's awareness, especially innovative on the appearance of the orthodontic appliance.

The orthodontic appliance in the present invention is made by plastic materials and having thickness thereof; also, the inner side thereof is a concave shape that can be installed on the molar.

Furthermore, the orthodontic appliance in the present invention is made by plastic materials and having thickness along vertical direction; besides, the inner side thereof is a concave shape that can be installed on the deciduous molar.

According to the present invention, the orthodontic appliance is made by white plastic materials.

The orthodontic appliance in the present invention is made by white plastic material and having a molar shape with thickness along vertical direction, and the inner side thereof is a concave shape that can be installed on the molar. Therefore, when the orthodontic appliance is installed on patient's teeth, the occlusion will be higher, the space in the month cavity is larger, and the tongue moving range is wider. Constantly using the orthodontic appliance can move the jaw position toward the ideal position through the pressure caused by the interaction between tongue portion and the cheek portion, so as to expand the moving space of the teeth. As a result, the teeth move toward the neutral zone with better balance and the best treatment effect can be achieved.

Also, the orthodontic appliance made by plastic material can cause less pain during treatment and have X-ray penetrability.

Further, due to the white plastic materials, the orthodontic appliance can be invisible or unawareness to others and the user can dine while the orthodontic appliance is thereon. Moreover, compared to the removable orthodontic appliance, the treatment duration can be manifestly shortened.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1 illustrates the top view of the orthodontic appliance applied to the upper second deciduous molar 2A in the present invention;

FIG. 2 illustrates the bottom view of an orthodontic appliance applied to the upper second deciduous molar 2A in the present invention;

FIG. 3 illustrates the side view of an orthodontic appliance applied to the upper second deciduous molar 2A in the present invention;

FIG. 4 illustrates the top view of the upper jaw gypsum mold 6 without the orthodontic appliance;

FIG. 5 illustrates the top view of the upper jaw gypsum mold 6 with the orthodontic appliances;

FIG. 6 illustrates the top view of the lower jaw gypsum mold 7 without the orthodontic appliance;

FIG. 7 illustrates the top view of the lower jaw gypsum mold 7 with the orthodontic appliances;

FIG. 8 illustrates the front view of the upper jaw gypsum mold 6 without the orthodontic appliance;

FIG. 9 illustrates the front view of the upper jaw gypsum mold 6 with the orthodontic appliances;

FIG. 10 illustrates the front view of the lower jaw gypsum mold 7 without the orthodontic appliance;

FIG. 11 illustrates the front view of the lower jaw gypsum mold 7 with the orthodontic appliances; and

FIG. 12 illustrates the standard prediction of the teeth in time sequence during the orthodontic treatment.

### DETAILED DESCRIPTION

Exemplary embodiments of the present invention are described herein in the context of an orthodontic appliance. The invention and its various embodiments can now be better understood by turning to the following detailed description of the preferred embodiments. Those of ordinary skilled in the art will realize that the following detailed description of the exemplary embodiments is illustrative only and is not intended to be in any way limiting. Reference will now be made in detail to implementations of the exemplary embodiments as illustrated in the accompanying drawings. The same reference indicators will be used throughout the drawings and the following detailed description to refer to the same or like parts.

The orthodontic appliance in the present invention is made by white plastic materials and has a molar shape. Also, the orthodontic appliance has thickness along vertical direction, and the inner side thereof is formed a concave shape that can be installed on the molar. When actually performing the treatment, the orthodontic appliance is installed on patient's back deciduous teeth by adhesive for fastening the orthodontic appliance. Because the orthodontic appliance in the present invention has thickness along vertical direction, the occlusion will be changed, the mouth cavity will be widened, and the moving area of the tongue will be larger when the orthodontic appliance is installed on the teeth. If constantly using under this situation, the tongue and the cheek can interact with each other, the jaw position can be moved toward the ideal position, the frequently used and important first molar is protruded from the current position and moved toward the neutral zone with best balance to the children, and the whole teeth can be guided to the correct position.

Moreover, due to the white plastic materials, the orthodontic appliance can be constantly used without others' notice or awareness, and therefore the advantages of wearing the orthodontic appliance more frequently and having better treatment result can be gained.

Following are the orthodontic appliances, illustrated by modules in accordance with the embodiments in the present invention.

The orthodontic appliances in accordance with one embodiment of the present invention are applied to a patient (a 7 years and 6 month old boy) with deciduous teeth, the main problem sought to be solved is the malocclusion of the first molar.

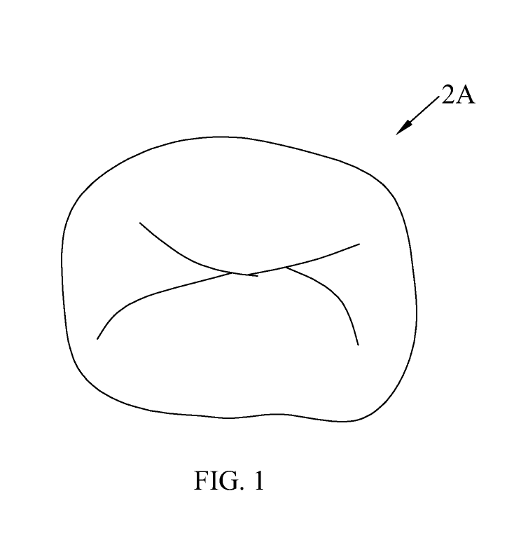

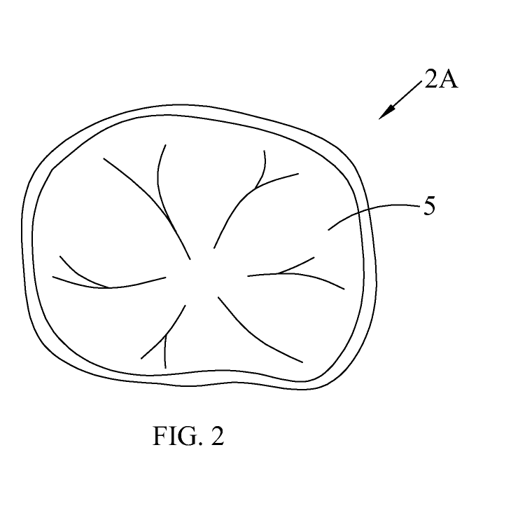

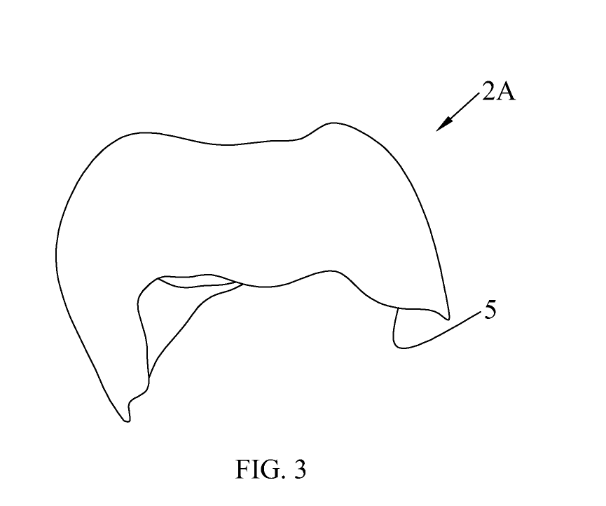

The orthodontic appliances in accordance with the embodiment are the upper first deciduous molar orthodontic appliances (1A and 1B), the upper second deciduous molar orthodontic appliances (2A and 2B), the lower first deciduous molar orthodontic appliances (3A and 3B), and the lower second deciduous molar orthodontic appliances (4A and 4B); there are totally eight orthodontic appliances. FIG. 1 to FIG. 3 are respectively the top view, the bottom view, and the side view of the upper second deciduous molar orthodontic appliance 2A. From FIG. 2 and FIG. 3, the inner side of the orthodontic appliance is formed for installing on patient's concave portion 5. Therefore, the orthodontic appliance has concave portion for installing on patient's tooth.

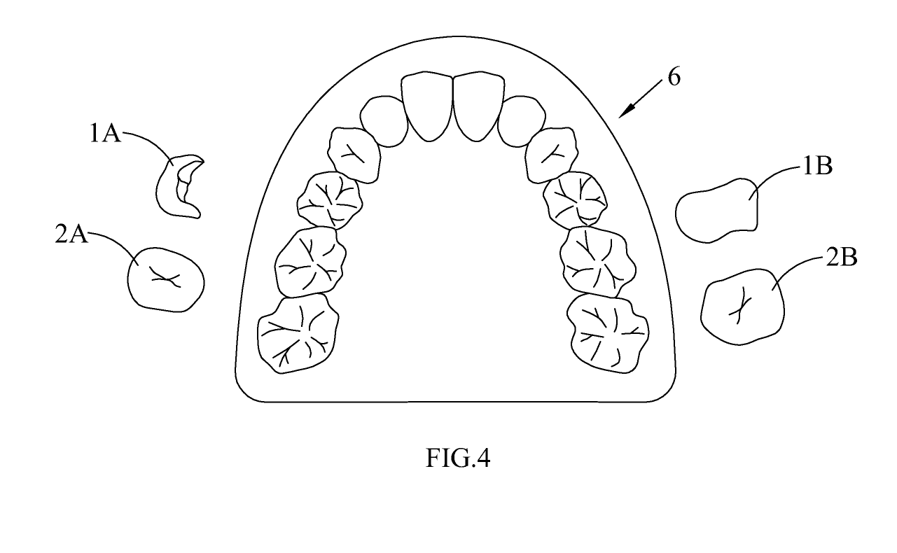

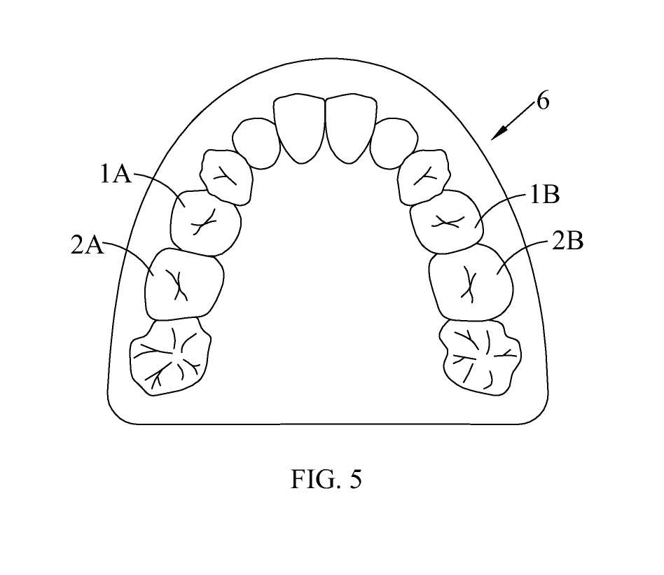

FIG. 4 is the top view of the upper jaw gypsum mold 6 without the orthodontic appliance. In FIG. 4, the upper first deciduous molar orthodontic appliances (1A and 1B) and the upper second deciduous molar orthodontic appliances (2A and 2B) are shown on the left and right hand side of FIG. 4 respectively. FIG. 5 is the top view of the upper jaw gypsum mold 6 with the orthodontic appliances. The upper first deciduous molar orthodontic appliances (1A and 1B) and the upper second deciduous molar orthodontic appliances (2A and 2B) are installed on the upper first deciduous molars and the upper second deciduous molars in the upper jaw gypsum mold 6 respectively. The fixed mechanism in the embodiment is using adhesive, however, any one of the fixed mechanism can be used as long as the fixed mechanism is easily removable.

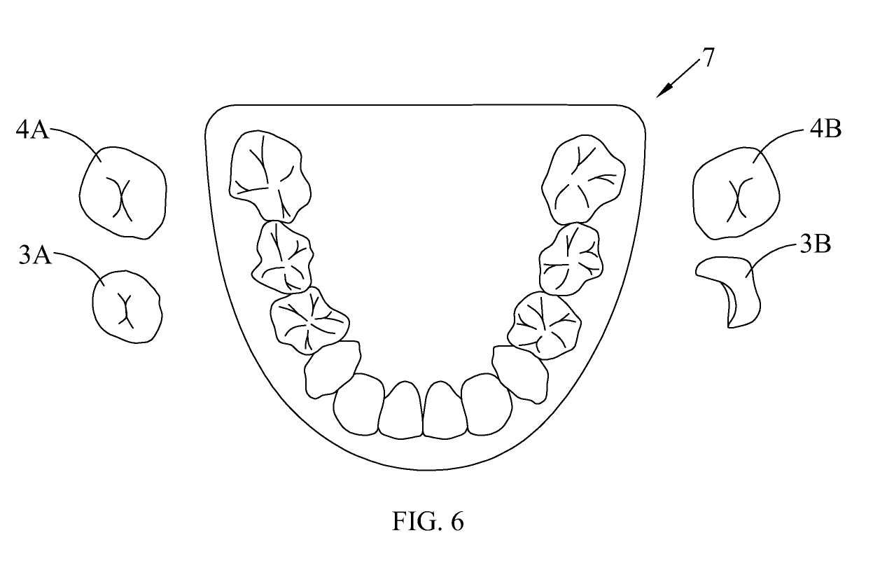

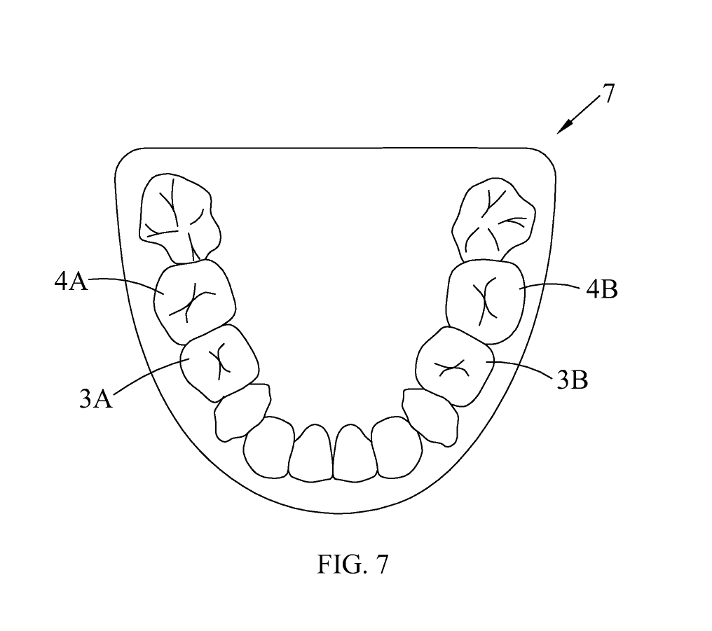

FIG. 6 is the top view of the lower jaw gypsum mold 7 without the orthodontic appliance. In FIG. 6, the lower first deciduous molar orthodontic appliances (3A and 3B) and the lower second deciduous molar orthodontic appliances (4A and 4B) are shown on the left and right hand side of FIG. 6 respectively. FIG. 7 is the top view of the lower jaw gypsum mold 7 with the orthodontic appliance. The lower first deciduous molar orthodontic appliances (3A and 3B) and the lower second deciduous molar orthodontic appliances (4A and 4B) are installed on the lower first deciduous molars and the lower second deciduous molars in the lower jaw gypsum mold 7 respectively.

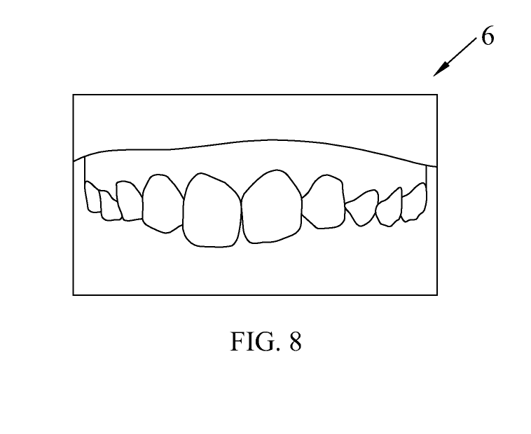

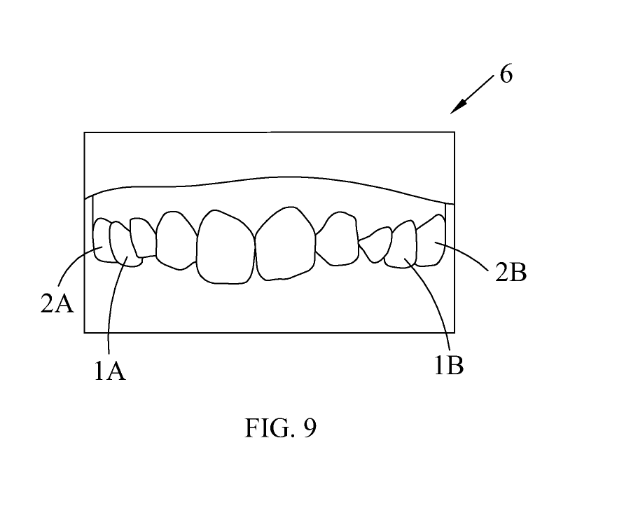

FIG. 8 illustrates the front view of the upper jaw gypsum mold 6 without the orthodontic appliance. The upper first deciduous molars and the upper second deciduous molars are located at the regular altitude. FIG. 9 illustrates the front view of the upper jaw gypsum mold 6 with the orthodontic appliances. The upper first deciduous molar orthodontic appliances (1A and 1B) and the upper second deciduous molar orthodontic appliances (2A and 2B) are installed on the upper first deciduous molar and the upper second deciduous molar in the upper jaw gypsum mold 6 respectively. It can be seem that the orthodontic appliances have thickness along the vertical direction.

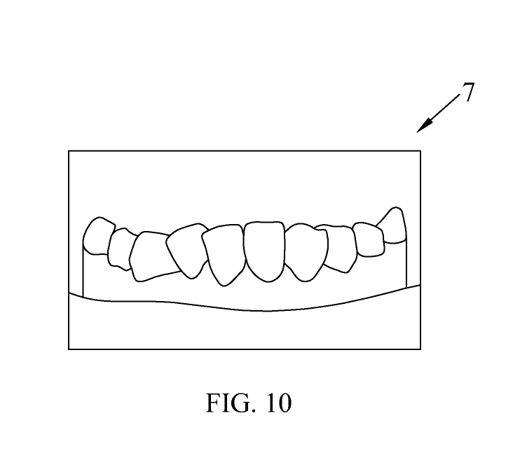

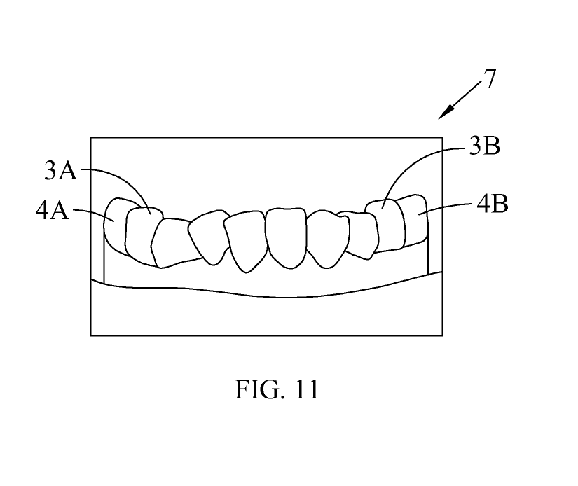

FIG. 10 illustrates the front view of the lower jaw gypsum mold 7 without the orthodontic appliance. The lower first deciduous molars and the lower second deciduous molars are located at the regular altitude. FIG. 11 illustrates the front view of the lower jaw gypsum mold 7 with the orthodontic appliances. The lower first deciduous molar orthodontic appliances (3A and 3B) and the lower second deciduous molar orthodontic appliances (4A and 4B) are installed on the lower first deciduous molars and the lower second deciduous molars in the lower jaw gypsum mold 7 respectively. It can be seem that the orthodontic appliances have thickness along the vertical direction.

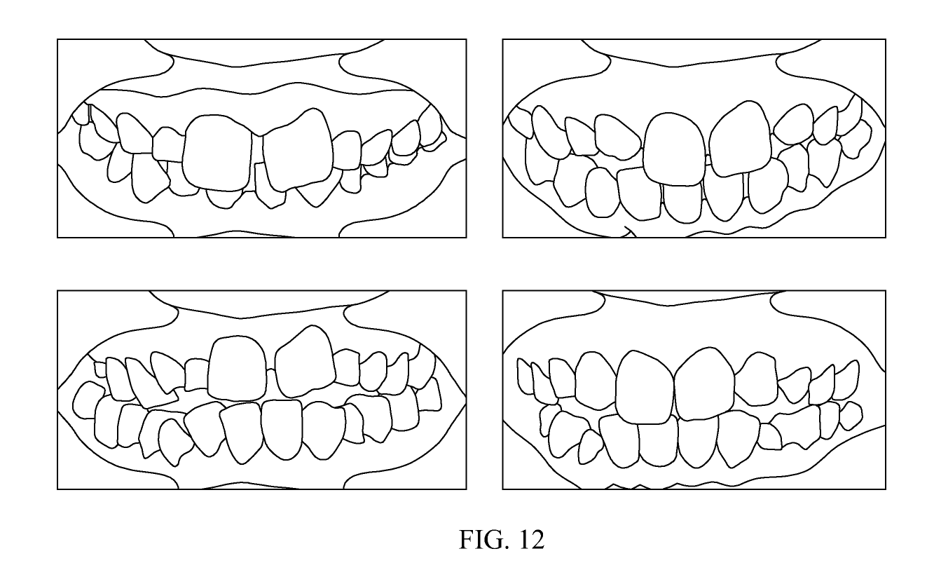

FIG. 12 is the standard prediction of the teeth in time sequence during the orthodontic treatment. The figure on the left top corner is the front view of the teeth before the treatment (before applying the orthodontic appliances); the figure on the left bottom corner is the front view of the teeth installed with the orthodontic appliance of the upper first and second deciduous molar orthodontic appliances and the lower first and second deciduous molar orthodontic appliances in accordance with one embodiment of the present invention; the figure on the right top corner is the front view of the teeth after 9 months treatment, and the figure on the right bottom corner is the front view of the teeth after 18 months treatment.

Besides, the orthodontic appliance are installed on children's upper first deciduous molars, upper second deciduous molars, lower first deciduous molars, and the lower second deciduous molars, total eight deciduous molars. Even in the situation that the deciduous teeth all have been fallen out except one, the installation on the remained single tooth still has effect. Thus, the number of the orthodontic appliances is not limited. The desired treatment timing is the growing period that the two front teeth of the upper permanent teeth and the four front teeth of the lower permanent teeth are moved to be in order. However, if the best treatment timing is passed, the treatment still has its effect. For example, the treatment to the lower molar (lateral incisor)_still has effect when the upper second front molar, counted from the center, has not grown yet. In addition, the orthodontic appliances in the present invention can be used with other orthodontic appliances, such as Bimler. The treatment result is different case by case, the synergic effect can be also produced and sometimes ideal result can be achieved solely by using the present invention. Moreover, in the aforementioned embodiment, the orthodontic appliance is also_used for children with deciduous teeth because moving the permanent molar to the correct position will have significant effect. However, the occlusion will become higher because of the installation of the orthodontic appliance so as to easily move the teeth. Thus, the orthodontic appliance can apply not only to children but also to adult or to children without deciduous teeth, and still have effect thereon. Furthermore, the orthodontic appliance in the present invention can be customized and be made in different size beforehand, so the customized orthodontic appliance can be installed according to the size of patient's teeth in a convenient manner.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiments of the present invention.

What is claimed is:

1. An orthodontic appliance, comprising:
plastic materials that comprise a thickness along a vertical direction; and
an inner side thereof having a concave shape corresponding to a molar.

2. The orthodontic appliance as recited claim 1, wherein the plastic materials are white plastic materials.

3. An orthodontic appliance, comprising:
plastic materials that comprise a thickness along a vertical direction; and
an inner side thereof having a concave shape corresponding to a deciduous molar.

4. The orthodontic appliance as recited claim 3, wherein the plastic materials are white plastic materials.
